(19) United States
(12) Patent Application Publication
(10) Pub. No.: US 2009/0210802 A1
(43) Pub. Date: Aug. 20, 2009

(54) LOCATION INFORMATION IN PRESENCE

(75) Inventors: Quinn Hawkins, Kirkland, WA (US); Kapil Sharma, Woodinville, WA (US); Avronil Bhattacharjee, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/033,861

(22) Filed: Feb. 19, 2008

(51) Int. Cl. G06F 3/048; G06F 15/16; G06F 15/167

(52) U.S. Cl. 715/753; 709/204; 709/203; 709/217

(57) ABSTRACT

Architecture that facilitates the combining and presentation of location information with presence information in a communications system. The location information can be virtual location information published from a location source and/or associated location systems to a presence system. The presence system then makes the virtual location information available to end users as participants to a conferencing session, for example, or as invites to the session. The location information and/or the presence information can be made active (e.g., a hyperlink) such that when selected as presented to a user, automatically joins the user to the session.

### BACKGROUND

A new generation of applications can process and expose presence information of a user or entity. In the context of online users, the presence information of an individual allows other users or entities to know the current “state” of that individual. The state has been limited to broad activity categories such as free, busy, away, offline, etc. New versions of presence applications are including additional information such as physical locations. While this can be useful, information workers are increasingly working in virtual locations. The employee virtual locations can include web conference meetings, project sites, and collaborative sessions over documents, for example.

Web conferencing applications can maintain a roster of participants in a meeting and show a separate and different presence such as in-meeting roll, audio and video status, some or all of the content currently being viewed or perceived in the meeting, and the quality of a participant connection. The in-meeting roster presence contains information for fellow meeting participants, but the in-meeting roster presence is limited only to in-meeting events.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture facilitates the combining and presentation of location information with presence information in a communications system. In one specific implementation, the location information includes virtual location information published from a location source and/or associated location systems to a presence system. The presence system then makes the virtual location information available to end users as participants to a conferencing session, for example, or as invites to the session.

The location information and/or the presence information can be made active (e.g., a hyperlink) such that when selected as presented to a user, automatically joins the user to the session. This can solve the problem of information workers not knowing if an individual will be interrupted when requesting to consult about a specific project and knowing the best way to get in touch with the individual.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and equivalents. Other advantages and novel features will become apparent from the following detailed description when considered in conjunction with the drawings.

### BRIEF DESCRIPTION OF THE DRAWINGS

FIG. 1 illustrates a computer-implemented communications system for presenting location information as part of the presence information.

FIG. 2 illustrates an exemplary system that facilitates the presentation of presence information and location information to users.

FIG. 3 illustrates an exemplary session roster of a communication program for presenting presence and location information.

FIG. 4 illustrates a method of providing communications information.

FIG. 5 illustrates an alternative method of providing communications information.

FIG. 6 illustrates a block diagram of a computing system operable to process and present location information and presence information in accordance with the disclosed architecture.

### DETAILED DESCRIPTION

Knowing the virtual location of an individual is valuable information which can indicate the tasks or projects the individual is currently working on and how best to communicate with that individual. The disclosed architecture obtains, combines, and presents location information with presence information in a communications system.

In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. Reference is now made to the drawings, wherein like reference numerals are used to refer to like elements throughout.

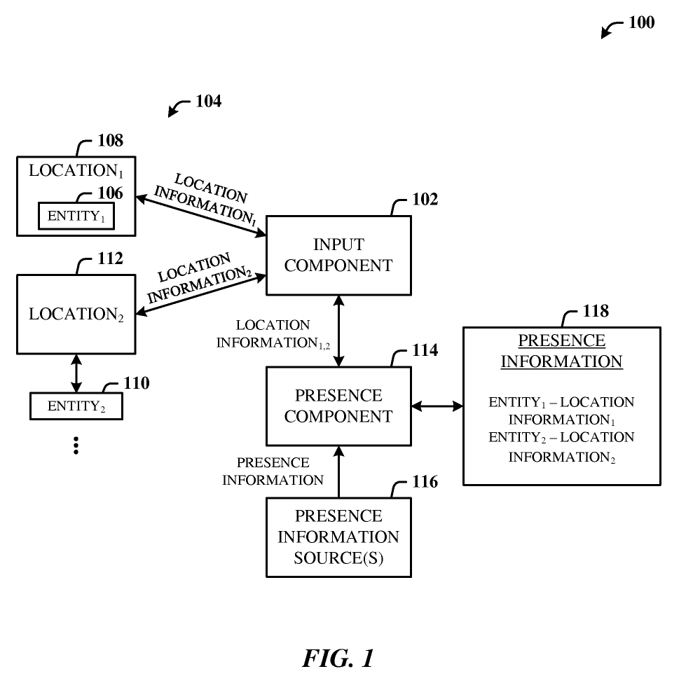

FIG. 1 illustrates a computer-implemented communications system 100 for presenting location information as part of the presence information. The system 100 includes an input component 102 for receiving location information of entities associated with entity locations 104. For example, an entity can be a user or a user device (e.g., cell phone, computer, IP phone, PSTN (public-switched telephone network) phone, or any other device or system for which location information can be derived). Entity locations can include physical locations such as conference rooms, vehicles, homes, hotels (and hotel rooms).

One technique for identifying an entity location is via global positioning system (GPS) by determining the latitude/longitude (lat/long) information of the user device (and hence, the user), and interpreting this information into a more readily understandable format (e.g., hotel name versus lat/long coordinates) for perception by a user. Other techniques include the processing of caller ID information to determine the location of the user, device identifiers, subscriber identity (of a provider system, e.g., cellular provider, IP provider) associated with a device (e.g., cell phone, IP-based device).

Entity locations (and associated location information) can also include virtual locations such as a network-based call conference session, a collaboration session, video session, and so on. For virtual locations, the location information can be a URI (uniform resource identifier), a hyperlink (e.g., HTTP link), a SIP (session initiation protocol) address, and so on, that identifies the session. For example, a first entity 106 can be at a physical entity location 108 such as a conference room. A second entity 110 can be logged into a web-based virtual location 112 such as a collaboration session. Other locations 104 can also be involved for sending location information to the input component 102. Note that the location information can be provided to the input component 102 either directly or indirectly (via provider systems). For example, associated with a location or entity (e.g., corporate, commercial, etc.) can be computer infrastructure that generates the location information for communication to a network-based presence component 114. In a corporate environment, the presence component 114 can be an enterprise service that continually receives and processes the location information for presentation in combination with the presence information. A phone call associated with a particular user office, desktop computer, or conference room can be processed as the basis for the location information. More specifically, the enterprise maintains a list of office information associated with a particular user, such as IP address via which substantial packet traffic can indicate that the user is at the location of the desktop computer, or IP traffic via a VoIP phone can indicate the location information, etc. Another example includes a wireless access point (AP) via which the user may connect. Registration to the enterprise network via an identifiable AP can define the location of the user by office (employee), building (of the employee office), geographic location (Building A of the Redmond, Wash., corporate location), etc.

Outside the enterprise, connection to an AP can indicate the location of the user relative to a hot-spot (e.g., coffee house, restaurant, city building, etc.). In this case, the computing infrastructure can be specific to the business, but then feed this location information to a presence system on the Internet, for example, for processing and routing to an application that presents the location information in combination with the presence information to a user device or system.

With respect to mobile and mobile-capable devices the computing infrastructure is part of the cellular provider. When the user commences mobile communications this activity can be monitored by the cellular provider systems, interpreted into location information and sent to the presence component 114. For example, cellular providers include location services that can determine the approximate geographic location of a caller. This is due in part to E911 services for use in emergence situations. This information can be provided to the presence component 114 for interpretation and presentation to one or more users of the session. If a user was on a cell call while at the airport, this location information (“at the airport”) could be communicated and presented in combination with the presence information (“at the airport-on a call”).

The system 100 also includes a presence component 114 for receiving presence information from one or more presence information sources 116 and presenting the presence information and the location information in a conferencing session. The location information (e.g., virtual, physical) is converted and presented in a user understandable format. In other words, the presence and/or location information can be presented via a display, in an audio format (e.g., interactive voice response), message, etc. The location information can also be made actionable (e.g., a hyperlink) where a user can select the location information to join the session. In other words, a user could be presented with the presence and location (e.g., virtual information) as an active link of a fellow participant before the session, during the session, and/or after the session. If the user chooses to join, the user can simply select (or click) on the active link presented and be joined into the session in response to this action.

In one implementation, the location information and presence information can be received directly into the input component 102 for processing and presentation. In an alternative implementation, the location information and presence information are received separately into the input component 102 from corresponding location and presence systems. In yet another implementation, the location information is published to the presence information source(s) 116, which presence source(s) 116 then sends both the location information and presence information to the input component 102.

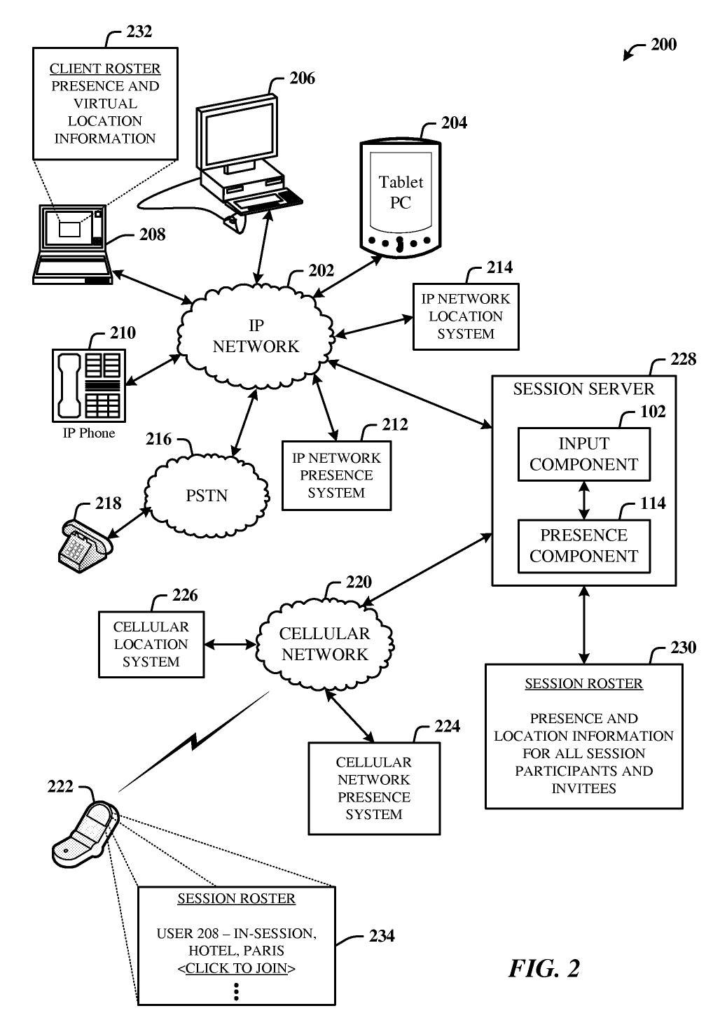

FIG. 2 illustrates an exemplary system 200 that facilitates the presentation of presence information and location information to users. The system 200 can include multiple different types of communications entities. Some or all of the entities can include the capability to present the presence and location information. Moreover, some or all of the entities are associated with a computer infrastructure that can uniquely identify the entity, which then provides the basis for determining the presence and location information for other session participants and invitees. For example, devices connected to an IP network 202 can include, but are not limited to, a tablet PC 204, a desktop computer 206, a portable computer 208, and a VoIP phone 210 (for at least IP-based phone calls over the IP network 202). The IP network 202 also has disposed thereon an IP network presence system 212 and an IP network location system 214 for determining and providing location information (e.g., virtual, physical)

The system 202 also includes a PSTN network 216 for providing communications for terrestrial phones 218. The PSTN 216 can interface to the IP network 202 for communications between the phones 218 and IP-based systems and devices (e.g., portable computer 208, IP phone 210, etc.).

The system 200 also includes a cellular network 220 for providing connectivity for mobile-capable devices, for example, a cell phone 222. The cellular network 220 can also include a cellular network presence system 224 for computing presence information and a cellular location system 226 for computing virtual and/or physical location of the user (and user device).

The presence systems (212 and 224) and the location systems (214 and 226) can push the presence information and/or the location information to the input component 102 of a session server 228 for combining by the presence component 114 into the server session roster 230 of presence and location information for all session participants and/or invitees. Alternatively, or in combination with the push mechanism, the session server 228 can pull the presence and/or location information from the sources (systems 212, 214, 224 and/or 226) based on criteria associated with the server session, for example.

As illustrated, the portable computer 208 runs a client application that facilitates the presentation of a client roster version 232 of some or all of the presence and virtual location information 230. In other words, the amount of presence and location information 230 provided to the portable computer 208 for presentation can be based on the state (e.g., participant in the session, invitee but not a participant, etc.) of the user of the portable computer 208. For example, if the invitee (user of computer 208) has yet to join the session, the invitee can be restricted seeing only the session organizer, such that joining will be via an active link presented in association with the organizer (or leader). In another example, the invitee can be allowed to see all session participant location and presence information. These restrictions or constraints can be driven by server policies, for example, imposed by an enterprise.

As further illustrated, the cell phone 222 can run a client application that facilitates the presentation of a phone roster version 234 of some or all of the presence and virtual location information 230. Here, the user of the cell phone 222 may be traveling in a vehicle when receiving the invite to join the session. The cell phone client can present presence and location information related to the user of the portable computer 208 indicating that the user (“208”) presence is now currently a participant in the session, and the location from which the user is participating is currently from a hotel in Paris. The invitee can then join the session using an active link (“click to join”) also presented for invitee interaction. The phone roster version 234 can also present other presence and location information for other invitees and/or participants of the session.

It is to be understood that the session presence and location information can be sent via email, text messaging, or other conventional communications means, such that the recipient of the email, message, or communication can interact with an active link to join the session. Interaction can include selecting (or clicking) on the link to join, or copying and pasting the link into a program which automatically navigates and connects a client communication program to the session for the client user.

It is also within contemplation of the subject architecture that the phone roster version 234 can present presence and location information for more than one session such that the user of the cell phone 222 can choose to join different sessions (e.g., a video session, an audio session, collaboration session, etc.).

More specifically, a user has a client communications application running that is compatible with processing session server data and signals, including presence information and location information. This communications application can run as a background process transparent to the user actions with the client system (e.g., cell phone, portable computer). The user can receive an email that includes a link to the session, and which the selection of which joins the user to the session hosted by the server 228. By joining, the client communications program is now aware that the user in the session, looks at the session information (e.g., session title or name “Software Design Meeting”), and updates the user presence to indicate “in session”, for example. The client communications program passes the active link (e.g., URL) with client presence information up to the session server 228. The server 228 can then publish this information to any entity (user, device or system) subscribed to the user's presence.

Thus, entities that include the user in a buddy list or an entity that searches for the user inside of corporate address book, for example, can then obtain the user's name. As part of obtaining (e.g., pulling) the user name, the client machine can query the session server 228 or other presence sources to also obtain the user presence information. The presence information can include a string to the conference session and a URI or URL of that session. The user client communication program processes the presence information and also provides a link to the conference location using the URI, URL, or some other method, and exposes the presence and location information to one or more users for interaction to join the session as well.

In another example, the user of the tablet PC 204 could be in a conference room that is associated with a conference room phone number. The phone number can be used as the identifier for location information, which phone number can then be translated into more user-friendly location information such as “Conf. Rm. B13, Bldg. 5”. The fact that the tablet PC user accepted an invitation to a meeting scheduled for that conference room can be obtained from scheduling software on the tablet PC 204, or a network service that tracks this information centrally, and provides one piece of data from which location information can be derived. If the tablet PC users dials out from the conference room using a conference room phone and is required to enter a user-identifiable PIN, this additional information can be used to device the location information. If the user connects to the corporate network wirelessly via the tablet PC 204, the AP information can be used to generally estimate that the user should be in the conference room. In other words, multiple pieces of data (e.g., entry of user PIN, connection to AP that covers the conference room, user accepted scheduled meeting for that conference room, etc.) can be combined to infer probabilistically that the tablet PC user is in the conference room. Once inferred, the location information and/or the presence information for the tablet PC user can be published not only to the tablet PC 204, but to all subscribers seeking this information.

The user of the tablet PC 204 could also be engaged or invited to a virtual location for a video conference session hosted on a web-based conferencing server. It then becomes possible not only for the user of the tablet PC to view the presence and location information of others in the video conference session, but also to publish presence and location information to the user of the cell phone 222, for example, for the session occurring in the conference room. Again, the presence and location information can be presented before, during, and/or after the session.

In yet another exemplary implementation, the location (e.g., physical) itself can join the session. In this instance, the physical location (e.g., a Conference Room A) can include a computing system or other uniquely identifiable and associated source of information (e.g., video or audio conferencing system) via which one or more conference users joined the session. If a user, for example, checked the status of the Conference Room A, the status can indicate that the conference room is joined to a particular session. In one implementation, this is based on the user having permission to view this conference room information. Additionally, the user can search a room and determine to which meeting that room is joined.

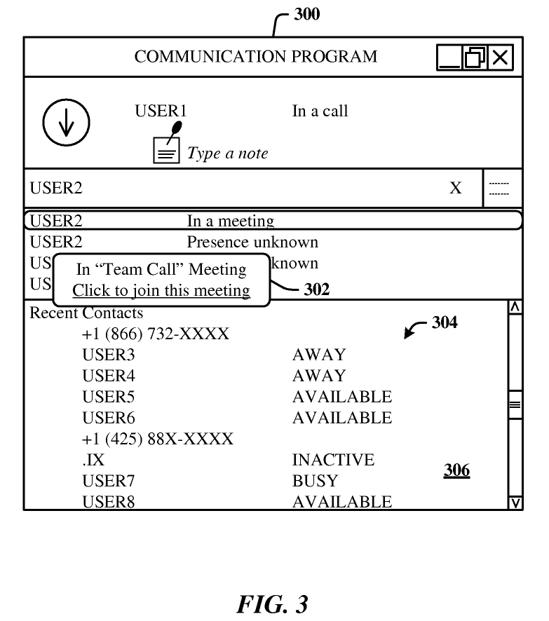

FIG. 3 illustrates an exemplary session roster 300 of a communication program (application) for presenting presence and location information. Since an increasing number of meetings are being conducted virtually (e.g., web conferencing, collaboration, etc.), the location information for these virtual meetings can now be presented along with the presence information. As illustrated, the disclosed architecture provides more specific information, not just basic presence information that the user is “in a meeting” but that the user is specifically “In Team Call Meeting” thereby providing location information in combination with the presence information in the session roster 300. For example, the state for USER1 is shown as “in a call”. Here, a popup box 302 can be presented (e.g., by hovering the mouse pointer over the associated user or selecting the user) indicating that a USER2 is specifically in a meeting called Team Call. Additionally, an interactive link (“Click to join this meeting”) in the popup box 302 is presented to allow USER1 to join the Team Call meeting. The general presence and location information 304 for other users is provided below in a Recent Contacts pane 306.

In an alternative implementation, once an invitee user is presented with the presence and location information, the invitee can be provided one or more options to obtain more detailed information about the session, such as how long the session has been underway, how long until the scheduled duration concludes, how long before start of the session, what session participants have contributed, what session participants have not contributed, session participants who have left (e.g., left entirely, muted, engaged in a sidebar session, etc.), and so on.

Following is a series of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

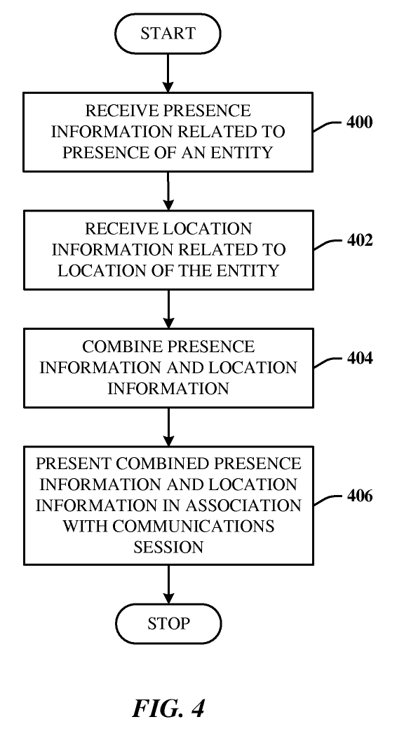

FIG. 4 illustrates a method of providing communications information. At 400, presence information related to presence of an entity is received. At 402, location information related to location of the entity is received. At 404, the presence information and the location information are combined. At 406, the location information is presented with the presence information in association with a communications session.

The location information defines virtual or physical location of a user or user device. The selection of the active link automatically joins the entity to the session. In one implementation, a presence system publishes the location information and the presence information to another entity, one or more of before, during, or after a communications session. Moreover, presentation of one or more of the presence information or the location information can be based on one or more permissions of the user to receive the information. This can be imposed using a server policy, for example, that stipulates that only the required permission(s) (e.g., employee, team member, etc.) will allow this information to be accessed by an invitee or other entity type.

In the following scenario, Participant A is in a web conferencing meeting. A coworker, Invitee B, wants to join Participant A and others in the meeting, but does not know the meeting address. Invitee B does know that Participant A will be attending the meeting. Invitee B opens up an application that allows for finding users associated user presence. Invitee B finds Participant A and sees that Participant A's location shows that Participant A is in the virtual meeting. Invitee B then clicks the meeting location and joins the web conference. Invitee B found the virtual location via the presence information.

The presence information can be pulled from a presence source and/or the location information can be pulled a source of the location information. Alternatively, as previously indicated, the presence information can be pushed from the presence source and/or the location information can be pushed from the source of the location information. Additionally, additional information can be presented in addition to the presence information and the location information.

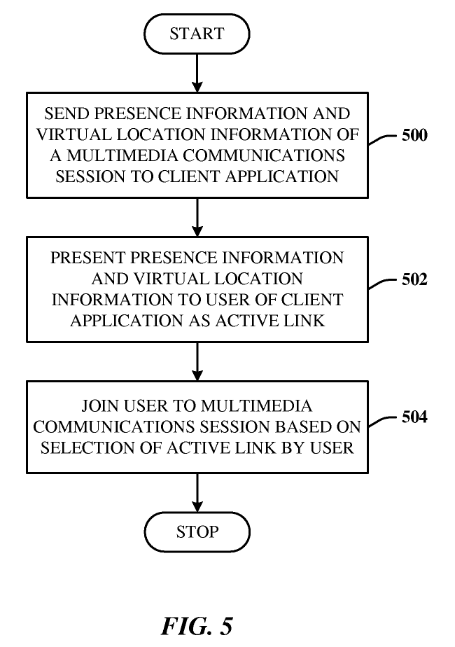

FIG. 5 illustrates an alternative method of providing communications information. At 500, the presence information and virtual location information related to a multimedia communications session is sent to a client application. At 502, the presence information and the virtual location information are presented to a user of the client application as an active link. At 504, the user is joined to the multimedia communications session based in selection of the active link by the user.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

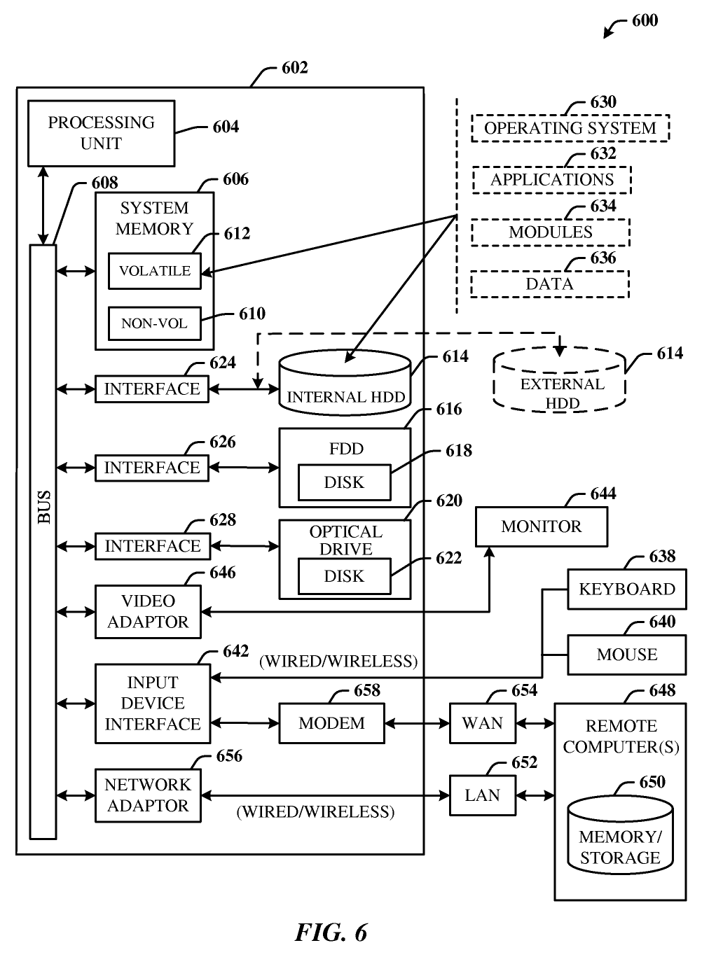

Referring now to FIG. 6, there is illustrated a block diagram of a computing system 600 operable to process and present location information and presence information in accordance with the disclosed architecture. In order to provide additional context for various aspects thereof, FIG. 6 and the following discussion are intended to provide a brief, general description of a suitable computing system 600 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 6, the exemplary computing system 600 for implementing various aspects includes a computer 602 having a processing unit 604, a system memory 606 and a system bus 608. The system bus 608 provides an interface for system components including, but not limited to, the system memory 606 to the processing unit 604. The processing unit 604 can be any of various commercially available processors. Dual microprocessors and other multi-processor architectures may also be employed as the processing unit 604.

The system bus 608 can be any of several types of bus structure that may further interconnect to a memory bus (with or without a memory controller), a peripheral bus, and a local bus using any of a variety of commercially available bus architectures. The system memory 606 can include non-volatile memory (NON-VOL) 610 and/or volatile memory 612 (e.g., random access memory (RAM)). A basic input/output system (BIOS) can be stored in the non-volatile memory 610 (e.g., ROM, EPROM, EEPROM, etc.), which BIOS are the basic routines that help to transfer information between elements within the computer 602, such as during start-up. The volatile memory 612 can also include a high-speed RAM such as static RAM for caching data.

The computer 602 further includes an internal hard disk drive (HDD) 614 (e.g., EIDE, SATA), which internal HDD 614 may also be configured for external use in a suitable chassis, a magnetic floppy disk drive (FDD) 616, (e.g., to read from or write to a removable diskette 618) and an optical disk drive 620, (e.g., reading a CD-ROM disk 622 or, to read from or write to other high capacity optical media such as a DVD). The HDD 614, FDD 616 and optical disk drive 620 can be connected to the system bus 608 by a HDD interface 624, an FDD interface 626 and an optical drive interface 628, respectively. The HDD interface 624 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 602, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 612, including an operating system 630, one or more application programs 632, other program modules 634, and program data 636. The one or more application programs 632, other program modules 634, and program data 636 can include a client for the processing and presentation of the presence information 118, and client rosters 232 and 234, for example, or the communication program 300.

Where the computing system 602 is employed as the session server 228, for example, the computing system 602 can include applications for the input component 102 presence component 114.

All or portions of the operating system, applications, modules, and/or data can also be cached in the volatile memory 612. It is to be appreciated that the disclosed architecture can be implemented with various commercially available operating systems or combinations of operating systems.

A user can enter commands and information into the computer 602 through one or more wire/wireless input devices, for example, a keyboard 638 and a pointing device, such as a mouse 640. Other input devices (not shown) may include a microphone, an IR remote control, a joystick, a game pad, a stylus pen, touch screen, or the like. These and other input devices are often connected to the processing unit 604 through an input device interface 642 that is coupled to the system bus 608, but can be connected by other interfaces such as a parallel port, IEEE 1394 serial port, a game port, a USB port, an IR interface, etc.

A monitor 644 or other type of display device is also connected to the system bus 608 via an interface, such as a video adaptor 646. In addition to the monitor 644, a computer typically includes other peripheral output devices (not shown), such as speakers, printers, etc.

The computer 602 may operate in a networked environment using logical connections via wire and/or wireless communications to one or more remote computers, such as a remote computer(s) 648. The remote computer(s) 648 can be a workstation, a server computer, a router, a personal computer, portable computer, microprocessor-based entertainment appliance, a peer device or other common network node, and typically includes many or all of the elements described relative to the computer 602, although, for purposes of brevity, only a memory/storage device 650 is illustrated. The logical connections depicted include wire/wireless connectivity to a local area network (LAN) 652 and/or larger networks, for example, a wide area network (WAN) 654. Such LAN and WAN networking environments are commonplace in offices and companies, and facilitate enterprise-wide computer networks, such as intranets, all of which may connect to a global communications network, for example, the Internet.

When used in a LAN networking environment, the computer 602 is connected to the LAN 652 through a wire and/or wireless communication network interface or adaptor 656. The adaptor 656 can facilitate wire and/or wireless communications to the LAN 652, which may also include a wireless access point disposed thereon for communicating with the wireless functionality of the adaptor 656.

When used in a WAN networking environment, the computer 602 can include a modem 658, or is connected to a communications server on the WAN 654, or has other means for establishing communications over the WAN 654, such as by way of the Internet. The modem 658, which can be internal or external and a wire and/or wireless device, is connected to the system bus 608 via the input device interface 642. In a networked environment, program modules depicted relative to the computer 602, or portions thereof, can be stored in the remote memory/storage device 650. It will be appreciated that the network connections shown are exemplary and other means of establishing a communications link between the computers can be used.

The computer 602 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented communications system, comprising:
an input component for receiving location information of entities associated with entity locations; and
a presence component for combining the location information with presence information for presentation in association with a conferencing session.

2. The system of claim 1, further comprising a client-based communications application for receiving and presenting the combined location information and the presence information in association with a roster of usernames and, presenting the combined location information and presence information of a user in response to hovering on a corresponding username.

3. The system of claim 2, wherein the communications application presents one or more additional options for obtaining more detailed information about the session and session participants.

4. The system of claim 1, wherein the location information is virtual location information that defines a virtual location of an entity and, is converted and presented in a user understandable format.

5. The system of claim 4, wherein the virtual location information is actionable such that a user can join the session by selecting the virtual location information.

6. The system of claim 4, wherein the virtual location information is provided to a session invitee in a message as a user interactionable item, the item including a session identifier as a URI and based on SIP (session initial protocol).

7. The system of claim 4, wherein the virtual location information includes a session identifier.

8. The system of claim 7, wherein the virtual location information is provided to a session invitee in an email and in the form of an HTTP link which when selected joins the invitee into the session.

9. The system of claim 1, wherein the location information is received from a virtual source that publishes the location information to a presence system, the presence system sending the combined location information and presence information to a client program for presentation and user interaction.

10. A computer-implemented method of providing communications information, comprising:
receiving presence information related to presence of an entity;
receiving location information related to location of the entity;
combining the presence information and the location information; and
presenting the combined location information and the presence information in association with a communications session.

11. The method of claim 10, wherein the location information defines virtual or physical location of a user or user device.

12. The method of claim 10, further comprising automatically joining the entity to the session in response to selection of an active link.

13. The method of claim 10, further comprising publishing the location information and the presence information to another entity one or more of before, during, or after a communications session.

14. The method of claim 10, further comprising presenting one or more of the presence information or the location information based on permission.

15. The method of claim 10, further comprising pulling the presence information from a presence source or the location information from a source of the location information.

16. The method of claim 10, further comprising presenting additional information in addition to the presence information and the location information.

17. The method of claim 10, further comprising providing a link to the session according to a communications technology, the link including the presence information and location information, and the selection of the link connecting the entity to the session.

18. The method of claim 17, wherein the communications technology includes email and text messaging, and the link included therein includes at least one of URI or a URL.

19. A computer-implemented method of providing communications information, comprising:
sending presence information and virtual location information related to a multimedia communications session to a client application;
presenting the presence information and the virtual location information to a user of the client application as an active link; and
joining the user to the multimedia communications session based on selection of the active link by the user.

20. The method of claim 19, further comprising joining the user to the multimedia communications session via at least one of an audio channel technology or a video channel technology.
